(19) United States
(12) Patent Application Publication
(10) Pub. No.: US 2009/0044654 A1
(43) Pub. Date: Feb. 19, 2009

(54) Module for the Manufacturing of Automated Moving Structures and Automated Moving Modular Structure

(76) Inventor: Lucio Vaccani, Lecco (IT)

Correspondence Address: Modiano & Associati, Via Meravigli, 16, Milan, 20123, IT

(21) Appl. No.: 11/988,551

(22) PCT Filed: Jul. 19, 2006
(86) PCT No.: PCT/IB2006/002014

§ 371 Date: Jan. 10, 2008

(30) Foreign Application Priority Data
Jul. 20, 2005 (IT) MI2005A001392

(51) Int. Cl. B25J 18/06

(52) U.S. Cl. 74/490.01; 74/490.05; 901/22; 901/27

(57) ABSTRACT

A module for the manufacturing of automated moving structures, comprising a first substantially plate-like element and a second substantially plate-like element, which face each other and are mutually articulated so that they can oscillate by way of the interposition of hinge elements and elements for actuating the relative oscillation of the first and second substantially plate-like elements, the automated moving modular structure comprising two or more modules arranged in series to each other, the second substantially plate-like element of each module coinciding with the first substantially plate-like element of the module that follows it.

The present invention relates to a module for the manufacturing of automated moving structures and to an automated moving modular structure.

### BACKGROUND OF THE INVENTION

Industrial robots of the programmable type have long been known which are used as a replacement of human beings in performing autonomously and automatically repetitive, complex or dangerous work or operations, such as the handling and movement of objects, tools or instruments.

Industrial robots are used in several industrial sectors, for example to handle parts being machined, handle tools such as welding and/or cutting heads or paint guns, or to assemble or disassemble products, in analysis laboratories, for example to handle dangerous substances, in the medical field, for example to perform diagnostic or surgical procedures, and in other fields.

One of the main mechanical components of an industrial robot is the so-called articulated arm, i.e., the handling element provided with a hand or head for gripping the object, tool or instrument to be moved or handled.

The articulated arms of known robots suffer drawbacks, including the fact that they have low movement speeds; in industrial applications, this causes, for example, disadvantageously long processing or production times.

Another drawback of conventional articulated arm consists in that they do not allow to provide and control complex motion paths.

Another drawback of conventional articulated arm consists in that they are bulky and require a large maneuvering area, and this prevents their use in tight and confined spaces that are difficult to reach.

### SUMMARY OF THE INVENTION

The aim of the present invention is to eliminate the drawbacks noted above of the articulated arms of industrial robots of the known type by providing a module for providing automated moving structures with high movement speeds.

Within this aim, an object of the present invention is to provide a module for the manufacturing of automated moving structures that allow to provide and control with precision even complex motion paths.

Another object of the present invention is to provide a module for the manufacturing of automated moving structures that are compact and require reduced maneuvering areas, so as to be able to work even in tight and confined spaces or spaces which are difficult to reach.

Another object of the present invention is to provide a module for the manufacturing of automated moving structures that is flexible and can be adapted easily to different uses.

Still another object of the present invention is to achieve said aim and objects with a structure which is simple, relatively easy to provide in practice, safe in use, effective in operation, and relatively low in cost.

This aim and these and other objects, which will become better apparent hereinafter, are all achieved by the present module for the manufacturing of automated moving structures, characterized in that it comprises a first substantially plate-like element and a second substantially plate-like element, which face each other and are mutually articulated so that they can oscillate by way of the interposition of hinge means and means for actuating the relative oscillation of the first and second substantially plate-like elements.

In a preferred embodiment, the hinge means comprise a cylindrical hinge, which is provided between the first substantially plate-like element and the second substantially plate-like element and defines an axis for their mutual oscillation.

In another preferred embodiment of the module according to the invention, the axis of mutual oscillation of the first and second substantially plate-like elements is substantially parallel to their planes of arrangement.

This aim and these objects are also achieved by an automated moving modular structure, characterized in that it comprises at least one pair of said modules arranged in series to each other, the second substantially plate-like element of one of the modules of the pair coinciding with the first substantially plate-like element of the other module of the pair.

In a preferred embodiment, the modular structure according to the invention comprises a plurality of such modules arranged in series, the second substantially plate-like element of one of the modules of the series coinciding with the first substantially plate-like element of the module that follows it.

### BRIEF DESCRIPTION OF THE DRAWINGS

Further characteristics and advantages of the present invention will become better apparent from the detailed description of a preferred but not exclusive embodiment of a module for the manufacturing of automated moving structures and of an automated moving modular structure according to the invention, illustrated by way of non-limiting example in the accompanying drawings, wherein:

FIG. 1 is a perspective view of a module according to the invention, associated with respective motor means with the interposition of transmission means;

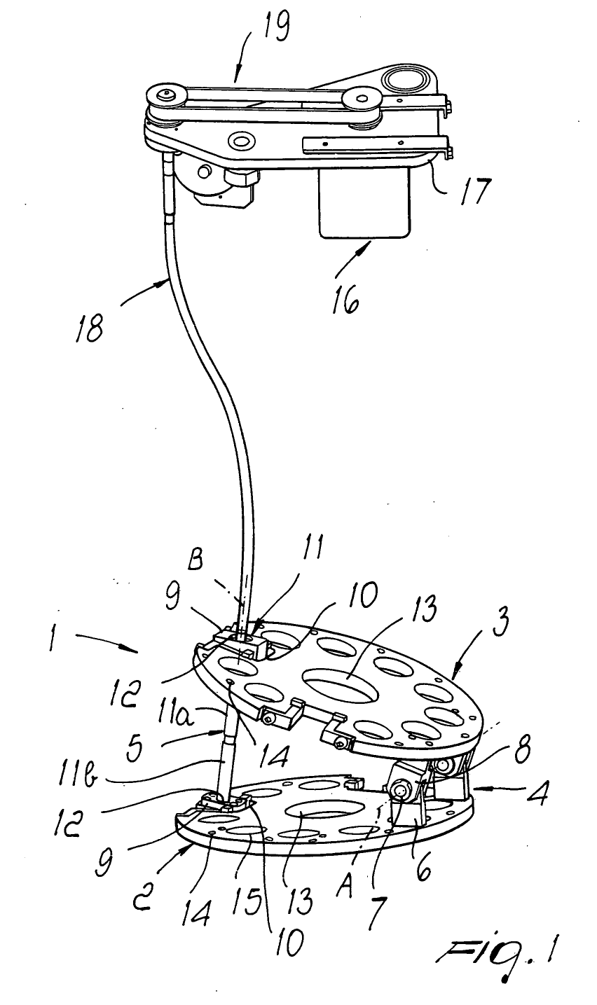

FIGS. 2 and 3 are schematic perspective views of two modules according to the invention, with the hinge means in two different positions;

FIG. 4 is a perspective view of an automated moving modular structure according to the invention in the open configuration;

FIG. 5 is a perspective view of an automated moving modular structure according to the invention in the closed configuration.

### DESCRIPTION OF THE PREFERRED EMBODIMENTS

With particular reference to the figures, reference numeral 1 generally designates a module for the manufacturing of automated moving structures.

It is specified that in the present description the adjectives “first” and “second” are used only to distinguish the elements that they specify, without this constituting any limitation of the protective scope of the present invention.

The module 1 comprises a first substantially plate-like element, which is constituted by a first plate 2, and a second substantially plate-like element, which is constituted by a second plate 3.

The first plate 2 and the second plate 3 face each other and are mutually articulated so as to oscillate by way of the interposition of hinge means 4. Means 5 for actuating their relative oscillation act between the first plate 2 and the second plate 3.

The hinge means 4 are constituted by a cylindrical hinge, which is provided between the first plate 2 and the second plate 3 and defines an axis A for their mutual oscillation; the relative oscillation axis A is substantially parallel to the planes of arrangement of the first plate 2 and of the second plate 3.

Variation of the relative distance of the hinge means 4, i.e., of the relative oscillation axis A, with respect to the center of the first plate 2 and of the second plate 3, causes a variation of the breadth of oscillation, in particular of the maximum breadth of oscillation, of the two plates, and therefore of distance or extent of the movement between corresponding points of the two plates.

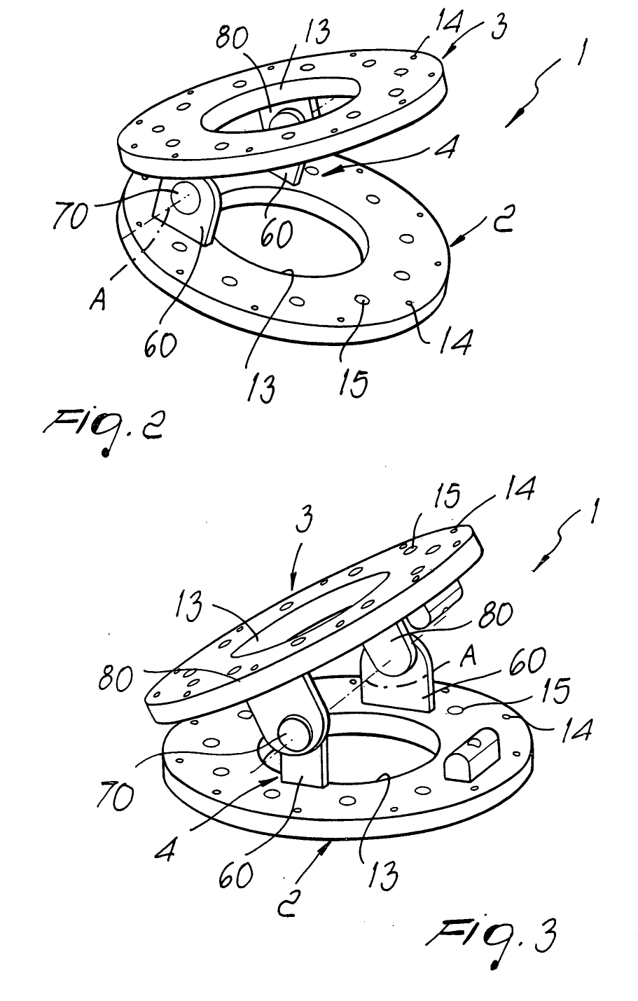

As shown in FIGS. 2 and 3, the farther the axis of relative oscillation A is spaced from the center of the first plate 2 and of the second plate 3, the greater the possibility of relative movement between the centers of the two plates.

In the illustrated embodiment, the cylindrical hinge comprises two lugs 6, which protrude on the surface of the first plate 2 that faces the second plate 3; each lug supports a pivot 7, the opposite ends whereof protrude in a cantilevered fashion from it in order to mate, with the interposition of rolling bearings, with a corresponding fork 8 which is provided so as to protrude on the surface of the second plate 3 that faces the first plate 2.

However, alternative embodiments of the cylindrical hinge, known to the person skilled in the art, are not excluded; for example, such hinge can be constituted by two supports 60 and 80, which protrude from the mutually facing surfaces of the first plate 2 and of the second plate 3 which support, with the interposition of rolling bearings, a respective articulation pivot 70.

In a preferred embodiment, the actuation means 5 are of the linear type and act along a direction B which is incident with respect to the planes of arrangement of the first plate 2 and of the second plate 3; the expression “actuation means of the linear type” is used to reference actuation means adapted to impart to two points between which they act a linear movement along a preset direction of mutual approach and/or spacing.

If the actuation means 5 are of the linear type, they act between two corresponding points of the first plate 2 and of the second plate 3, so that when the distance between said points varies, so does the aperture angle of the module 1, i.e., the angle formed between the mutually facing surfaces of the first plate 2 and of the second plate 3.

As the breadth of the aperture angle of the module 1 varies, so does the arrangement of the direction B; in order to assist this variation of arrangement, the opposite ends of the actuation means 5 of the linear type are associated with a respective supporting element 9, which is articulated, so that it can oscillate about an axis which is substantially parallel to the relative oscillation axis A, respectively to the first plate 2 and to the second plate 3.

Conveniently, the first plate 2 and the second plate 3 comprise a respective through seat 10 for accommodating and allowing the oscillation of the corresponding supporting element 9.

In a preferred embodiment, the actuation means 5 of the linear type comprise a shaft 11, which has, at its opposite ends, two threaded portions 11a and 11b, which have mutually opposite threads, a left-handed one and a right-handed one, not shown, and are coupled to corresponding female threads 12, for example of the ballscrew type, which are rigidly associated with the respective supporting element 9, the shaft 11 being adapted to be turned in the two opposite directions.

Since the female threads 12 are rigidly coupled to the respective supporting element 9, by turning the shaft 11 in one direction or in the opposite direction the female threads 12 slide on the respective portion 11a and 11b, moving mutually closer or farther apart, and therefore moving closer or farther apart the first plate 2 and the second plate 3 with respect to each other, thus changing the aperture angle of the module 1.

However, alternative embodiments of the actuation means are not excluded; if they are of the linear type, they can be for example of the type operated by a fluid medium, such as hydraulic or pneumatic cylinders.

For example, the actuation means might also be of the nonlinear type, such as cams or articulated parallelogram systems.

The first plate 2 and the second plate 3 are substantially circular and comprise a central opening 13 for the containment and passage of service systems or parts thereof, such as for example optical fibers, pipes, cables or others.

The first plate 2 and the second plate 3 further have at least one reference hole 14 for positioning in series another module 1; preferably, the first plate 2 and the second plate 3 comprise a plurality of reference holes 14, which are distributed with a constant spacing along a first circumference that is substantially concentric thereto.

As will become better apparent from the description that follows, in a preferred embodiment the first plate 2 and the second plate 3 further comprise at least one passage hole 15 for means for transmitting motion to the actuation means 5. In another preferred embodiment, the first plate 2 and the second plate 3 comprise a plurality of passage holes 15, which are distributed, with a constant spacing, along a second circumference which is concentric thereto and has a radius which is conveniently shorter than the radius of the first circumference along which the positioning holes 14 are distributed.

The first plate 2 and the second plate 3 are provided with support or anchoring elements. Such support or anchoring elements are used in the case of complex structures formed by a large number of elements. For example, an articulated structure designed to inspect sewers, which are predominantly arranged horizontally, cannot stand only on its footing. In this case, it is convenient to arrange on certain plates pairs of supporting feet mounted on simple on-off actuators, which allow to support the weight and must be extracted and retracted in step, for example in the following manner.

While two pairs of feet are resting, the pair of intermediate raised feet advances by way of the extension of the preceding vertebrae and of the contraction of the subsequent vertebrae (as in the motion of a caterpillar).

The anchoring elements can instead have a dual function, similar to the preceding one, if the structure has a considerable vertical extension and is unable to maintain sufficient rigidity, for example underwater welding at great depths, or whenever the tool mounted on the head applies force to the structure itself; for example, a drilling head or a milling head performs more precise machining if it has anchoring elements adapted to rigidly couple the head to the part to be machined.

The module 1 further comprises motor means, which are associated with the actuation means 5 and are adapted to move them in the two opposite directions; if the actuation means 5 are of the linear type, in the opposite directions for increasing and reducing the relative distance between the two points of the first plate 2 and of the second plate 3 between which they act, in order to produce the relative oscillation of the first plate 2 and of the second plate 3.

Means for transmitting motion from the motor means to the actuation means 5 are further provided.

In a possible embodiment, the motor means are remote with respect to the actuation means 5 and are constituted by a motor 16 of the reversible type, which is supported by a bracket 17, and the transmission means are constituted by a flexible shaft 18, which receives at one end the motion from the motor 16, by way of the interposition of belt drive means 19, and whose opposite end is associated with the actuation means 5.

Conveniently, the bracket 17 is associated with a frame, not shown, which can move so as to compensate the length variations of the corresponding flexible shaft 18.

Each flexible shaft 18 is inserted in a corresponding passage hole 15 of the first plate 2 and of the second plate 3.

In another possible embodiment, the motor means and any transmission means are local with respect to the actuation means 5 and are supported by said first plate 2 and/or by said second plate 3.

By articulating two or more modules 1 in series with respect to each other, automated moving modular structures 20 are provided, such as for example articulated arms for handling or moving objects, parts, tools or instruments.

The second plate 3 of a module 1 of the structure 20 coincides with the first plate 2 of the module 1 that follows it.

A supporting footing and a conventional grip head can be associated respectively with the two end modules 1 of the structure 20.

With particular reference to the embodiment shown in the accompanying figures, the operation of the invention is as follows.

In order to mount a single module 1, it is necessary to mate the pivots 7 supported by the lugs 6 of the first plate 2 with the forks 8 that protrude from the second plate 3 and thus constitute the cylindrical hinge.

The two portions 11a and 11b of the shaft 11 are then inserted in the corresponding female threads 12 of the first plate 2 and of the second plate 3.

The shaft 11 is then coupled to one end of the corresponding flexible shaft 18, the opposite end whereof is connected to the motor 16 by way of the belt drive means 19.

By actuating the motor 16 it is possible to turn the flexible shaft 18, and accordingly the shaft 11 in one direction or in the opposite direction. A rotation in one direction or the other of the shaft 11 is matched by a mutual approach or spacing of the female threads 12 and therefore of the first plate 2 and of the second plate 3; a presettable and controlled movement is thus provided.

In order to assemble a structure 20 it is necessary to assemble in succession a plurality of modules 1 arranged in series.

With the aid of the reference holes 14, it is possible to orient according to a presettable criterion two successive modules 1 and therefore their relative oscillation axes A; different combinations allow to provide different possibilities of movement of the structure 20.

In order to change the mobility of the structure 20 it is also possible to couple modules 1 characterized by different distances between the oscillation axis A and the center of the respective first and second plates 2 and 3.

The actuation means 5 of each module 1 are further connected to the respective motor 16 by means of a corresponding flexible shaft 18, each module 1 being actuated autonomously.

The flexible shafts 18 are inserted within the passage holes 15 of each module 1 and reach the modules that follow it.

The brackets 17 that support the actuation motors 16 of the individual modules 1 are conveniently supported movably by a footing, so as to compensate for any movement of the structure 20.

A grip and handling head can be rigidly coupled to the free end of the structure 20.

By actuating the motors 16 according to a preset program it is possible to impart each module 1 a given oscillation and therefore a presettable movement; the movement of the structure 20 is determined by the composition of the oscillations and movements of each module 1 that composes it.

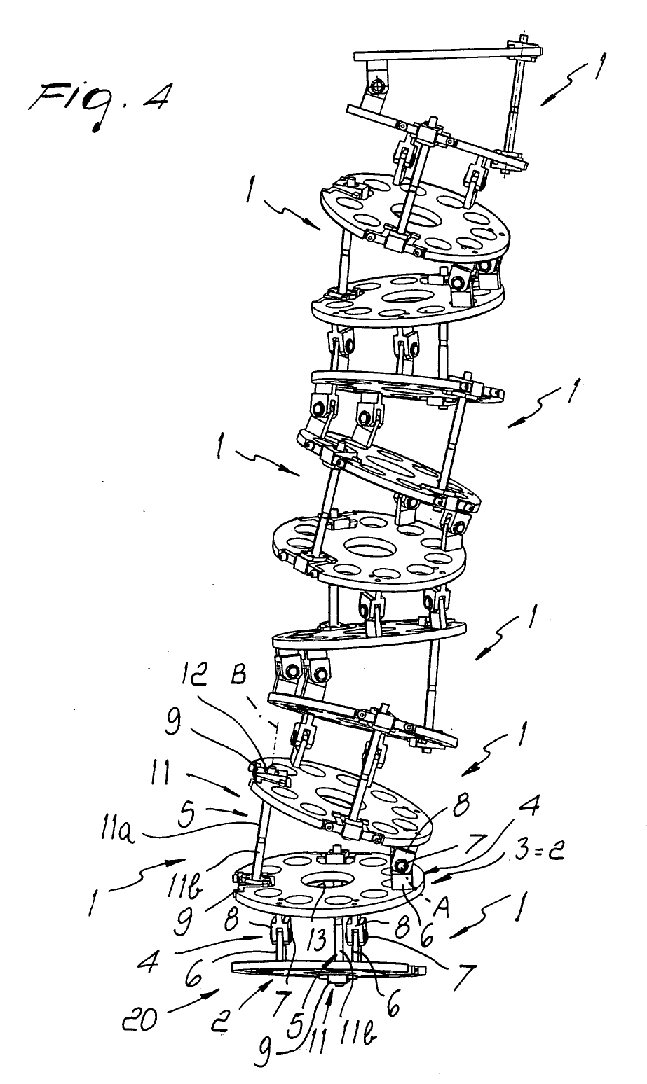

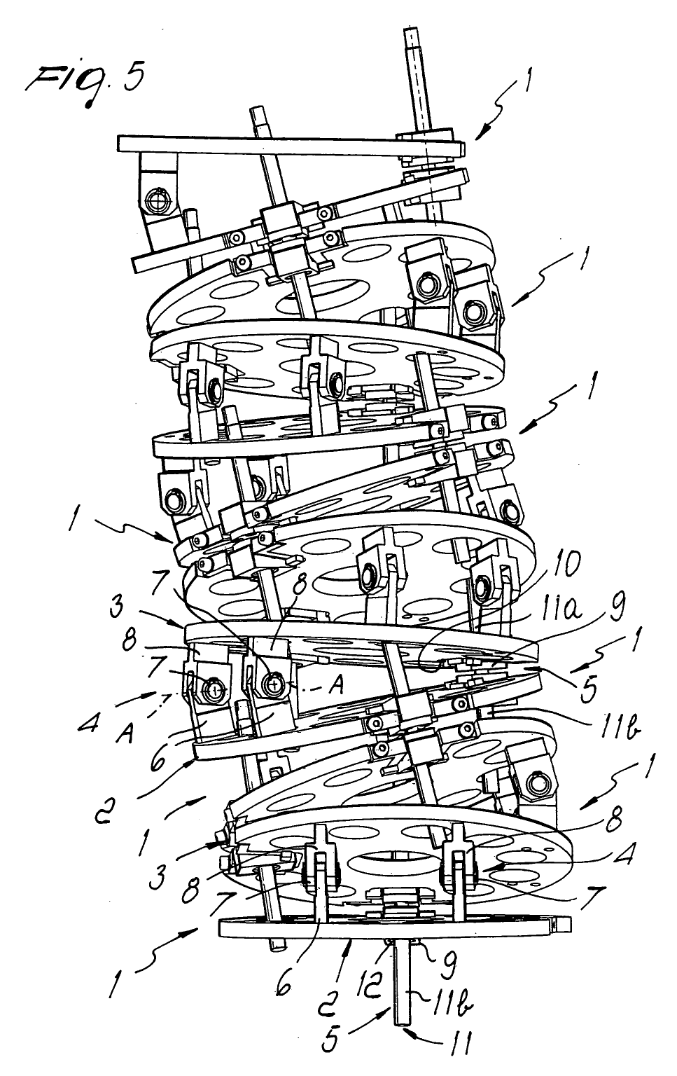

FIG. 4 is a view of a structure 20 in the open configuration, i.e., in the configuration of maximum extension, in which the aperture angle of each module 1 that composes it has the maximum possible breadth, whereas FIG. 5 shows a structure 20 in a closed configuration, i.e., a configuration of minimum extension, in which the aperture angle of each module 1 that composes it has the minimum possible breadth.

In practice it has been found that the described invention achieves the intended aim and objects.

The module according to the invention in fact allows to provide automated moving modular structures that have a very high speed of motion and allow to provide and control precisely even complex paths.

The automated moving modular structures according to the present invention are compact, require small maneuvering areas, and easily reach even tight and confined spaces.

The automated moving modular structures according to the present invention are flexible, can adapt easily to different applications and can be adopted for moving tools, such as for example laser or water-jet cutting heads, or for handling instruments in the medical field.

The automated moving modular structures according to the present invention are adapted to be miniaturized in order to be applied in particular in the medical field.

The invention thus conceived is susceptible of numerous modifications and variations, all of which are within the scope of the inventive concept.

All the details may further be replaced with other technically equivalent ones.

In practice, the materials used, as well as the shapes and dimensions, may be any according to requirements without thereby abandoning the scope of the protection of the appended claims.

The disclosures in Italian Patent Application No. MI2005A001392 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-24. (canceled)

25. A module for the manufacturing of automated moving structures, comprising a first substantially plate-like element and a second substantially plate-like element, which face each other and are mutually articulated so that they can oscillate by way of the interposition of hinge means and means for actuating the relative oscillation of said first and second substantially plate-like elements.

26. The module according to claim 25, wherein said hinge means comprise a cylindrical hinge, which is provided between said first substantially plate-like element and said second substantially plate-like element and defines an axis for their relative oscillation.

27. The module according to claim 26, wherein said oscillation axis is substantially parallel to the planes of arrangement of said first and second substantially plate-like elements.

28. The module according to claim 25, wherein said actuation means are of the linear type and act along a direction which is incident with respect to planes of arrangement of said first and second substantially plate-like elements.

29. The module according to claim 28, wherein said actuation means of the linear type have opposite ends associated with a respective supporting element, which is articulated so that it can oscillate about an axis which is substantially parallel to said relative oscillation axis respectively to said first substantially plate-like element and to said second substantially plate-like element.

30. The module according to claim 29, wherein each one of said first and second substantially plate-like elements comprises a through seating for accommodating and allowing the oscillation of said respective supporting element.

31. The module according to claim 29, wherein said actuation means of the linear type comprise a shaft which has, at its opposite ends, two threaded portions with mutually opposite threads, which are coupled to corresponding female threads rigidly associated with said respective supporting element, said shaft being adapted to be turned in the two opposite directions.

32. The module according to claim 28, wherein said actuation means of the linear type are of the type operated by a fluid medium.

33. The module according to claim 25, wherein each of said first and second substantially plate-like elements is substantially circular.

34. The module according to claim 25, wherein each of said first and second substantially plate-like elements comprises a central opening for the containment and passage of service systems or parts thereof.

35. The module according to claim 25, wherein each of said first and second substantially plate-like elements comprises at least one reference hole for the positioning of another said module.

36. The module according to claim 35, wherein each of said first and second substantially plate-like elements comprises a plurality of said reference holes, distributed along a first circumference which is substantially concentric thereto.

37. The module according to claim 25, wherein each of said first and second substantially plate-like elements comprises respective supporting or anchoring elements.

38. The module according to claim 25, comprising motor means associated with said actuation means.

39. The module according to claim 38, comprising motion transmission means which are interposed between said motor means and said actuation means.

40. The module according to claim 38, wherein said motor means are remote with respect to said actuation means.

41. The module according to claim 39, wherein said transmission means comprise a flexible shaft, which is turned by said motor means and is associated at one end with said actuation means.

42. The module according to claim 39, wherein each of said first and second substantially plate-like elements comprises at least one hole for the passage of said transmission means.

43. The module according to claim 42, wherein each of said first and second substantially plate-like elements comprises a plurality of said passage holes, distributed along a second circumference which is concentric thereto.

44. The module according to claim 39, wherein said motor means and said transmission means are local with respect to said actuation means.

45. An automated moving modular structure, comprising at least one pair of modules according to claim 25 arranged in series on each other, the second substantially plate-like element of one of the modules of said pair coinciding with the first substantially plate-like element of another module of said pair.

46. The structure according to claim 45, comprising a plurality of said modules arranged in series, the second substantially plate-like element of one of the modules of said series coinciding with the first substantially plate-like element of the module that follows said one of the modules.

47. The structure according to claim 46, comprising a base associated with one of the two end modules of said pair or of said series.

48. The structure according to claim 46, comprising a grip head, which is associated with one of the two end modules of said pair or of said series.
